(19) United States
(12) Patent Application Publication
(10) Pub. No.: US 2021/0132209 A1
(43) Pub. Date: May 6, 2021

(54) MIMO FREQUENCY-MODULATED CONTINUOUS-WAVE RADAR

(71) Applicant: Augmented Radar Imaging, Inc., Los Altos, CA (US)

(72) Inventors: Victor Shtrom, Los Altos, CA (US); Ketan N. Patel, Cupertino, CA (US); Darin T. Milton, Campbell, CA (US)

(73) Assignee: Augmented Radar Imaging, Inc., Los Altos, CA (US)

(21) Appl. No.: 16/672,530

(22) Filed: Nov. 4, 2019

(51) Int. Cl. G01S 13/34; G01S 7/35

(52) U.S. Cl. CPC G01S 13/347; G01S 7/352

(57) ABSTRACT

During operation, transmitters in the electronic device provide first and second FMCW radar signals, where carrier frequencies of the first and the second FMCW radar signals have a predefined variation as a function of time over a predefined frequency range, and the predefined variation as a function of time of a second carrier frequency of the second FMCW radar signal has a predefined delay relative to the predefined variation as a function of time of a first carrier frequency of the first FMCW radar signal. Furthermore, at least a receiver in the electronic device receives first and second reflected FMCW radar signals within a bandwidth of the receiver, where, at a given time, a frequency difference between carrier frequencies of the first and the second reflected FMCW radar signals, which corresponds to the predefined delay, is less than the bandwidth (and which may be less than a predefined value).

### BACKGROUND

### Field

The described embodiments relate to an electronic device that transmits and receives radar signals. Notably, the electronic device transmits a frequency-modulated continuous-wave (FMCW) radar signal and a delayed FMCW radar signal, which are received by a receiver to provide multi-input multi-output (MIMO) radar.

### Related Art

Electromagnetic waves in a radio frequency band (which is henceforth referred to as ‘radar’) can be used to determine information about one or more objects in an environment. For example, continuous or pulsed radar signals having a fundamental wavelength in the radio frequency band may be transmitted, and reflected radar signals from an object may be received. These reflected radar signals may be analyzed to determine the information, such as a range, an angle and/or a velocity of the object. In order to accurately measure the range, many radar systems use pulsed radar signals. However, the large bandwidth of the pulsed radar signals can increase the complexity and cost of these radar systems. For example, a receiver in a radar system may have an analog-to-digital (A/D) converter with a wide bandwidth, which may be difficult to implement and, thus, expensive.

Alternatively, accurate range measurements can be achieved using FMCW radar signals (which are sometimes referred to as ‘continuous-wave frequency-modulated radar signals’). In FMCW, a carrier or fundamental frequency of the radar signals may be swept or slewed at a predefined rate over a predefined frequency range. For example, the carrier frequency may be slewed using a sine wave, a sawtooth wave, a triangle wave or a square wave as a function of time. Therefore, at any instant in time, the radar signals may have a narrow bandwidth. If a receiver tracks the carrier frequency of the radar signals as a function of time, then the receiver may have a narrow bandwidth. This may make the receiver easier to implement, and may reduce the cost of the receiver.

Moreover, there are often confounding signals in many environments, which can make it difficult to determine the information about the object. For example, in many environments there may be spurious reflections that make it hard to determine the range, the angle and/or the velocity. In principle, the effect of the confounding signals can be reduced or eliminated using spatial and frequency diversity, e.g., using MIMO. Notably, radar signals having different carrier wavelengths (and, optionally, different polarizations) may be transmitted using antennas at different locations.

However, it is typically difficult to use FMCW with MIMO. Notably, in existing radar systems, the different carrier wavelengths used with MIMO cannot be received by a receiver with a narrow bandwidth. Instead, a large bandwidth receiver is usually needed, which eliminates the advantages of FMCW, and increases the complexity and cost of a radar system that uses MIMO.

### SUMMARY

An electronic device that performs radar measurements is described. This electronic device includes a first transmitter configured to communicatively couple to a first antenna, a second transmitter configured to communicatively couple to a second antenna, and at least a first receiver configured to communicatively couple to a third antenna. During operation, the first transmitter provides a first FMCW radar signal, where a first carrier frequency of the first FMCW radar signal has a predefined variation as a function of time over a predefined frequency range. Moreover, the second transmitter provides a second FMCW radar signal, where a second carrier frequency of the second FMCW radar signal has the predefined variation as a function of time over the predefined frequency range, and the predefined variation as a function of time of the second carrier frequency has a predefined delay relative to the predefined variation as a function of time of the first carrier frequency. Furthermore, the first receiver receives a first reflected FMCW radar signal and a second reflected FMCW radar signal within a first bandwidth of the first receiver, where the first reflected FMCW radar signal corresponds to the first FMCW radar signal and the second reflected FMCW radar signal corresponds to the second FMCW radar signal, and where, at a given time, a frequency difference between carrier frequencies of the first and the second reflected FMCW radar signals, which corresponds to the predefined delay, is less than the first bandwidth. Note that the first bandwidth may be less than a predefined value.

Moreover, the first receiver may concurrently receive the first reflected FMCW radar signal and the second reflected FMCW radar signal. In some embodiments, the first receiver may receive the first reflected FMCW radar signal and the second reflected FMCW radar signal based at least in part on the predefined variation as a function of time over the predefined frequency range. For example, the first receiver may adjust a center of the first bandwidth to track the predefined variation of the first carrier frequency and the second carrier frequency as a function of time over the predefined frequency range.

Furthermore, the electronic device may perform MIMO measurements using the first reflected FMCW radar signal and the second reflected FMCW radar signal.

Additionally, the first receiver may down convert the first reflected FMCW radar signal and the second reflected FMCW radar signal to baseband based at least in part on the predefined variation as a function of time over the predefined frequency range. In some embodiments, the first receiver may correct for the frequency difference or may discard an off-frequency baseband signal. Alternatively, the first receiver may not correct for the frequency difference.

Moreover, the electronic device may include a second receiver configured to communicatively couple to a fourth antenna. During operation, the second receiver may receive the first reflected FMCW radar signal and the second reflected FMCW radar signal within a second bandwidth of the second receiver, where the frequency difference is less than the second bandwidth. Furthermore, the second receiver may down convert the first reflected FMCW radar signal and the second reflected FMCW radar signal to baseband based at least in part on the predefined variation as a function of time over the predefined frequency range and the predefined delay. Additionally, the second receiver may correct for the frequency difference or may discard an off-frequency baseband signal. Alternatively, the second receiver may not correct for the frequency difference. Note that the second bandwidth may be less than the predefined value.

In some embodiments, the predefined variation as a function of time includes one of: a sine wave, a sawtooth wave (or a chirp), a triangle wave or a square wave.

Note that the first antenna and the third antenna may have a first polarization, and the second antenna and the fourth antenna may have a second polarization.

Another embodiment provides the electronic device with the first antenna, the second antenna and the third antenna.

Another embodiment provides a computer-readable storage medium for use with the electronic device. This computer-readable storage medium may include program instructions that, when executed by the electronic device, causes the electronic device to perform at least some of the aforementioned operations of the electronic device.

Another embodiment provides a method for performing radar measurements. The method includes at least some of the aforementioned operations performed by the electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a drawing illustrating an example of an environment that includes an electronic device in accordance with an embodiment of the present disclosure.

FIG. 2 is a drawing illustrating an example of operation of the electronic device of FIG. 1 in accordance with an embodiment of the present disclosure.

FIG. 3 is a flow diagram illustrating an example of a method for performing radar measurements in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that performs radar measurements is described. During operation, transmitters in the electronic device provide first and second FMCW radar signals, where carrier frequencies of the first and the second FMCW radar signals have a predefined variation as a function of time over a predefined frequency range, and the predefined variation as a function of time of a second carrier frequency of the second FMCW radar signal has a predefined delay relative to the predefined variation as a function of time of a first carrier frequency of the first FMCW radar signal. Furthermore, at least a receiver in the electronic device receives first and second reflected FMCW radar signals within a bandwidth of the receiver, where the first and the second reflected FMCW radar signals correspond, respectively, to the first and the second FMCW radar signals, and, at a given time, a frequency difference between carrier frequencies of the first and the second reflected FMCW radar signals, which corresponds to the predefined delay, is less than the bandwidth (and which may be less than a predefined value). In some embodiments, the receiver may receive the first and the second reflected FMCW radar signals based at least in part on the predefined variation as a function of time over the predefined frequency range. For example, the receiver may adjust a center of the bandwidth to track the predefined variation of the carrier frequencies as a function of time over the predefined frequency range.

By allowing the first and the second reflected FMCW radar signals to be concurrently received by the receiver, these measurement techniques may allow the receiver to be easier to implement. Moreover, the measurement techniques may allow MIMO to be used in conjunction with FMCW. Consequently, the measurement techniques may improve the performance of the radar measurements (such as improved object detection, identification, range, angle and/or velocity determination) while reducing the complexity and the cost of the electronic device.

In the discussion that follows, radar is used as an illustrative example of the measurement techniques. For example, the radar may involve radar signals having a fundamental or carrier frequency of 24 GHz, 76-81 GHz or 140 GHz (which corresponds to the fundamental or carrier wavelength of 0.01249 m, 3.843-3.7011 mm or 2.1414 mm), and/or another electromagnetic signal having a fundamental frequency in the radio or microwave frequency band. Moreover, the radar signals may be continuous wave and/or pulsed, may modulated (such as using frequency modulation or pulse modulation) and/or may be polarized. In particular, the radar signals may be FMCW or pulse-modulated continuous-wave, and may enable the use of MIMO. However, a wide variety of sensor techniques may be used in conjunction with or to implement the measurement techniques. For example, the sensor techniques may include: optical imaging in the visible spectrum or a visible frequency band, infrared, sonar, FLIR, optical imaging having a dynamic range or contrast ratio exceeding a threshold value (such as 120 dB), lidar, etc.

Moreover, in the discussion that follows, the electronic device may optionally communicate using one or more of a wide variety of communication protocols. For example, the communication may involve wired and/or wireless communication. Consequently, the communication protocols may include: an Institute of Electrical and Electronics Engineers (IEEE) 802.11 standard (which is sometimes referred to as ‘Wi-Fi®,’ from the Wi-Fi Alliance of Austin, Tex.), Bluetooth® (from the Bluetooth Special Interest Group of Kirkland, Wash.), another type of wireless interface (such as another wireless-local-area-network interface), a cellular-telephone communication protocol (e.g., a 3G/4G/5G communication protocol, such as UMTS, LTE), an IEEE 802.3 standard (which is sometimes referred to as ‘Ethernet’), etc.

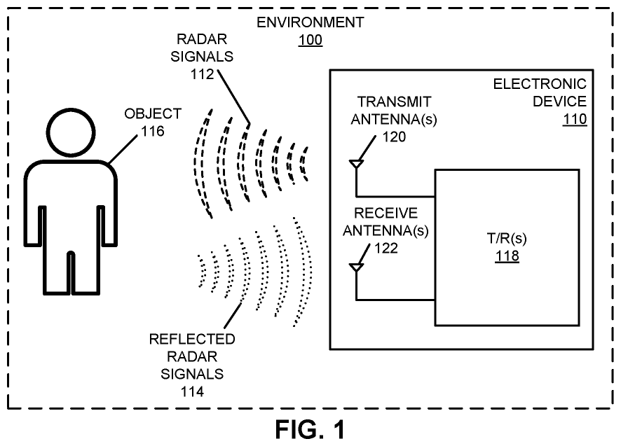

We now describe some embodiments of the measurement techniques. FIG. 1 presents a drawing illustrating an example of an environment 100 that includes an electronic device 110, such as an integrated circuit or an electronic device that includes an integrated circuit. This electronic device may transmit radar signals 112 having one or more carrier frequencies, and may receive reflected radar signals 114 having the one or more carrier frequencies. Note that the reflected radar signals 114 may have been reflected from one or more objects (such as object 116) in environment 100. For example, electronic device 110 may include one or more transmitters in one or more transceivers (T/R) 118 that provide electrical signals to one or more transmit antennas 120, which radiate the corresponding transmit radar signals 112. Moreover, the reflected radar signals 114 may be received by one or more receive antennas 122, which provide corresponding electrical signals to one or more receivers in the one or more transceivers 118. In some embodiments, different transmit antennas 120 and different receive antennas 122 may have different polarizations (such as horizontal, vertical, elliptical and/or circular). However, a given pair of a transmit antenna and a corresponding receive antenna may have the same polarization, such as a transmit antenna having a horizontal (or a vertical) polarization and a receive antenna having the horizontal (or the vertical) polarization.

In principle, the spatial, frequency and/or the polarization diversity provided by the one or more transceivers 118, the one or more transmit antennas 120 and the one or more receive antennas 122 may allow electronic device 110 to implement MIMO. For example, three transmitters and four receivers may be used provide MIMO for a given beam of transmitted radar signals 112. However, as noted previously, one challenge with this approach is that because different transmit radar signals 112 may have different carrier frequencies, the bandwidths of the receivers in the one or more transceivers 118 may be large or wide (such as e.g., 5 GHz), which may increase the cost and the complexity of the receivers.

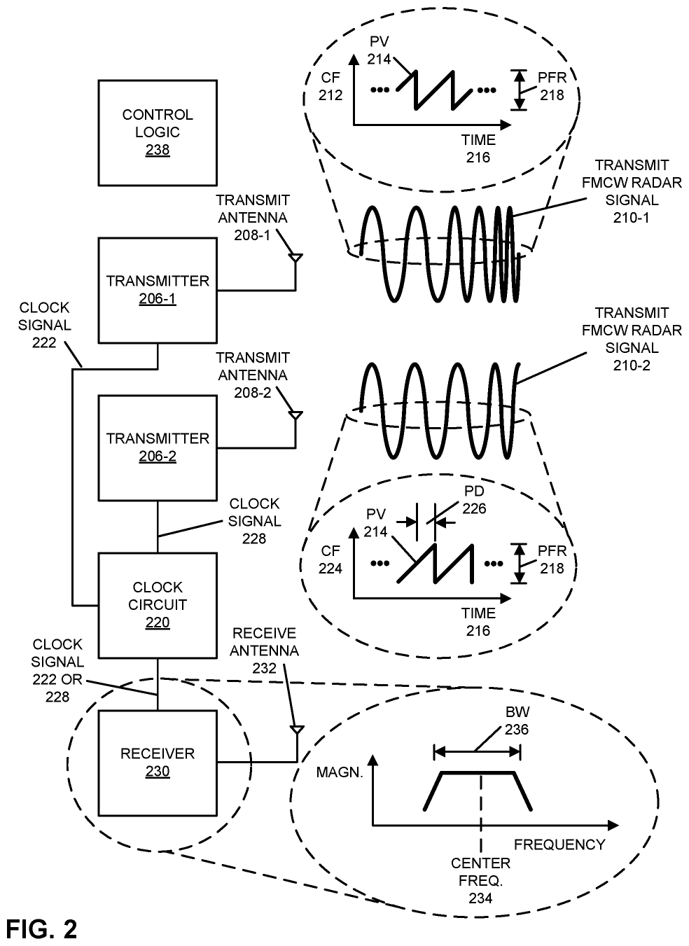

This problem may be addressed by the measurement techniques. Notably, as shown in FIG. 2, which presents a drawing illustrating an example of operation of the electronic device 110 in accordance with an embodiment of the present disclosure, transmitters 206 may provide (via transmit antennas 208) at least two transmit FMCW radar signals 210, such as transmit FMCW radar signals 210-1 and 210-2. As shown in the first two insets in FIG. 2, a carrier frequency of each of these transmit FMCW radar signals 210 may have a predefined variation (PV) 214 as a function of time 216 over a predefined frequency range (PFR) 218 (e.g., based on a clock signal 222 provided by clock circuit 220). Moreover, the predefined variation 214 as a function of time 216 of a carrier frequency (CF) 224 of the transmit FMCW radar signal 210-2 may have a predefined delay (PD) 226 relative to the predefined variation 214 as a function of time 216 of a carrier frequency 212 of the transmit FMCW radar signal 210-1 (e.g., based on a clock signal 228 provided by clock circuit 220). For example, the predefined variation 214 may include a chirp that varies a given carrier frequency between 76 and 81 GHz over 10 μs, and the predefined delay 226 may be 2 ns. Therefore, at a given time, a frequency difference between the carrier frequencies 212 and 224 may be 1 MHz. Alternatively, the chirp may vary the given carrier frequency between 76 and 81 GHz over 10 μs, the predefined delay 226 may be 20 ns, and the frequency difference may be 10 MHz. Consequently, at least a receiver 230 with, e.g., a bandwidth (BW) 236 of less than or equal to 10 MHz may concurrently receive (via receive antenna 232) reflected FMCW radar signals corresponding to the transmit FMCW radar signals 210 if a center frequency 234 of bandwidth 236 tracks the predefined variation 214 in the carrier frequencies 212 and 224 (e.g., the center frequency 234 tracks the predefined variation 214 as a function of time 216), such as based on clock signal 222 or 228 provided by clock circuit 220).

After receiving the reflected FMCW radar signals, receiver 230 may down convert them to baseband based at least in part on the predefined variation 214 as a function of time 216 over the predefined frequency range 218. In some embodiments, receiver 230 may correct for the frequency difference or may discard an off-frequency baseband signal. Alternatively, the first receiver may not correct for the frequency difference. For example, subsequent analysis performed by control logic 238 (such as a processor) may include or may incorporate the frequency difference as if it were a normal part of the baseband signals (such as in a machine-learning model). In some embodiments, the corrected or the uncorrected baseband signals may be used to implement MIMO or MIMO measurements. Thus, the measurement techniques may allow FMCW radar signals to be used in conjunction with MIMO.

Note that while processing the reflected FMCW radar signals, electronic device 110 (such as control logic 238) may perform additional operations to extract or determine information. For example, electronic device 110 may perform windowing or filtering, one or more Fourier or discrete Fourier transforms (with at least 128 or 256 bits), peak detection, etc. In some embodiments, a constant false alarm rate (CFAR) technique is used to identify or determine whether a peak in the received reflected FMCW radar signals is significant. Notably, electronic device 110 may calculate statistical metrics (such as a mean and a standard deviation) for a given range, and electronic device 110 may determine if a given peak is significant based on the calculated statistical metrics at different ranges. This approach may allow electronic device 110 to statistically identify or determine information associated with an object (such as object 116 in FIG. 1).

Moreover, electronic device 110 (such as control logic 238) may extract a signature associated with the object from the received reflected radar signals. The resulting signature of the object may include multiple dimensions. For example, the signature may include one or more of: a range to the object (such as time-of-flight information), a first angle to the object along a first axis (such as an azimuth direction), Doppler information associated with the object (such as velocity information) and/or a second angle to the object along a second axis (such as an elevation direction). Some or all of this information may be stored locally in electronic device 110 and/or remotely in a computer-readable memory.

Referring back to FIG. 1, while the preceding discussion illustrated electronic device 110 with a particular number of components, in other embodiments electronic device 110 may include additional components, fewer components, two or more components may be combined into a single component, a component may be divided into two or more separate components, and/or a position of one or more components may be changed. For example, in some embodiments, electronic device 110 may include one or more additional transmitters and/or one or more additional receivers, such as an additional instance of one or transmitters 206 (FIG. 2) and/or an additional instance of receiver 230 (FIG. 2). Moreover, while electronic device 110 is illustrated with one or more transceivers 118, as shown in FIG. 2 the one or more transceivers 118 may be replaced with one or more transmitters 206 and one or more receivers 230 (i.e., separate transmit and receive components).

Thus, in some embodiments, there may be more than two transmit FMCW radar signals, such as 2-10 or 2-20 transmit FMCW radar signals, where, at a given time, carrier frequencies of adjacent transmit FMCW radar signals may have a frequency difference of, e.g., 0.5 or 1 MHz. Note that, in some embodiments, transmit FMCW radar signals may be encoded, so that they are orthogonal to each other.

Additionally, while separate transmit antennas 120 and receive antennas 122 are illustrated in FIG. 1, in other embodiments at least some antennas may be shared between transmit and receive operations (i.e., duplex operation). In some embodiments, the transmit antennas 120 and/or the receive antennas 122 may include single or multiple radiators depending on the gain and beam width of a particular antenna configuration. In general, the transmit antennas 120 and/or the receive antennas 122 may have the same or different sizes. Moreover, the transmit antennas 120 and/or the receive antennas 122 may incorporate the same or different number and/or configurations of radiators. Note that the adjacent transmit antennas 120 and/or receive antennas 122 may be separated by greater than one half of the average carrier frequency in the transmit FMCW radar signals 210 (FIG. 2).

Furthermore, the transmit antennas 120 and the receive antennas 122 may be implemented using a wide variety of antenna structures and fabrication techniques, including multi-layer printed circuit board antennas with: microstrip feed lines and patch radiators, substrate integrated waveguide (SIW) feed lines and SIW slotted radiators, coplanar waveguide feed lines with SIW slotted radiators and/or other types of feed and radiator structures. In some embodiments, the transmit antennas 120 and/or the receive antennas 122 include high-gain antennas. Note that, in some embodiments, the transmit antennas 120 have 6-30 dB gain, a beam width between a few degrees and 180°, a transmit power of up to 12 dBm, and an effective range of 200-250 m.

Electronic device 110 may be used in a wide variety of applications. For example, electronic device 110 may be used in a vehicle. For example, the vehicle may include: a car or automobile, a bus, a truck, etc., and more generally one that includes one or more non-retractable wheels in contact with a surface (such as a road or the ground) during operation. Alternatively, electronic device 110 may be used in conjunction with a flying vehicle (such as a drone, a helicopter, an airplane, etc.), a boat or a ship, and/or a submersible vehicle (such as a drone or a submarine). In some embodiments, the measurement techniques may be used in: defense radar (such as air-defense and/or guided missile systems), marine radar, weather radar, aviation (such as flight control), air-traffic control, meteorology, automotive, navigation, outer-space surveillance, ground penetrating radar, radar astronomy, geology (such as ground-penetrating radar), and/or another radar application.

While the preceding embodiments illustrated the use of the measurement techniques in a predefined range of frequencies in a radar band of frequencies, in other embodiments the measurement techniques may be used in a different band of frequencies, such as: sonar, acoustic, ultrasound, infrared, visible, ultraviolet, x-ray, etc.

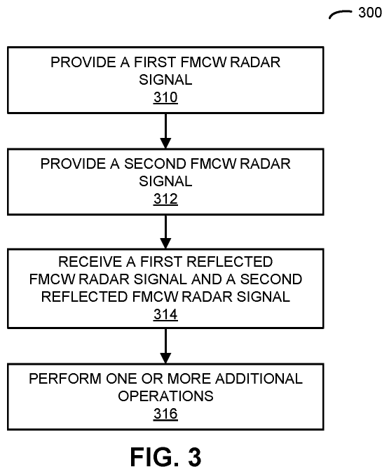

FIG. 3 presents a flow diagram illustrating an example of a method 300 for performing radar measurements. This method may be performed by an electronic device (such as electronic device 110 in FIGS. 1 and 2) or a component in the electronic device (such as an integrated circuit or a processor). During operation, a first transmitter in the electronic device may provide (via a first antenna) a first FMCW radar signal (operation 310), where a first carrier frequency of the first FMCW radar signal has a predefined variation as a function of time over a predefined frequency range. For example, the predefined variation as a function of time may include: a sine wave, a sawtooth wave (or a chirp), a triangle wave or a square wave. Moreover, a second transmitter in the electronic device may provide (via a second antenna) a second FMCW radar signal (operation 312), where a second carrier frequency of the second FMCW radar signal has the predefined variation as a function of time over the predefined frequency range, and the predefined variation as a function of time of the second carrier frequency has a predefined delay relative to the predefined variation as a function of time of the first carrier frequency. Note that the first FMCW radar signal may be provided concurrently with the second FMCW radar signal.

Furthermore, the first receiver in the electronic device may receive (via a third antenna) a first reflected FMCW radar signal and a second reflected FMCW radar signal (operation 314) within a first bandwidth of the first receiver, where the first reflected FMCW radar signal corresponds to the first FMCW radar signal and the second reflected FMCW radar signal corresponds to the second FMCW radar signal, and where, at a given time, a frequency difference between carrier frequencies of the first and the second reflected FMCW radar signals, which corresponds to the predefined delay, is less than the first bandwidth. Note that the first bandwidth may be less than a predefined value (such, e.g., as 10 MHz).

Note that the first receiver may concurrently receive the first reflected FMCW radar signal and the second reflected FMCW radar signal. In some embodiments, the first receiver may receive the first reflected FMCW radar signal and the second reflected FMCW radar signal based at least in part on the predefined variation as a function of time over the predefined frequency range. For example, the first receiver may adjust a center of the first bandwidth to track the predefined variation of the first carrier frequency and the second carrier frequency as a function of time over the predefined frequency range.

In some embodiments, the electronic device optionally performs one or more additional operations (operation 316). For example, the electronic device may perform MIMO measurements using the first reflected FMCW radar signal and the second reflected FMCW radar signal. Moreover, the first receiver may down convert the first reflected FMCW radar signal and the second reflected FMCW radar signal to baseband based at least in part on the predefined variation as a function of time over the predefined frequency range. Furthermore, the first receiver may correct for the frequency difference or may discard an off-frequency baseband signal. Alternatively, the first receiver may not correct for the frequency difference.

In some embodiments, the electronic device may include a second receiver configured to communicatively couple to a fourth antenna. During operation, the second receiver may receive (via a fourth antenna) the first reflected FMCW radar signal and the second reflected FMCW radar signal within a second bandwidth of the second receiver, where the frequency difference is less than the second bandwidth. Moreover, the first antenna and the third antenna may have a first polarization, and the second antenna and the fourth antenna may have a second polarization.

Furthermore, the second receiver may down convert the first reflected FMCW radar signal and the second reflected FMCW radar signal to baseband based at least in part on the predefined variation as a function of time over the predefined frequency range and the predefined delay. Additionally, the second receiver may correct for the frequency difference or may discard an off-frequency baseband signal. Alternatively, the second receiver may not correct for the frequency difference. Note that the second bandwidth may be less than the predefined value.

In some embodiments of method 300 there may be additional or fewer operations. Moreover, the order of the operations may be changed, and/or two or more operations may be combined into a single operation.

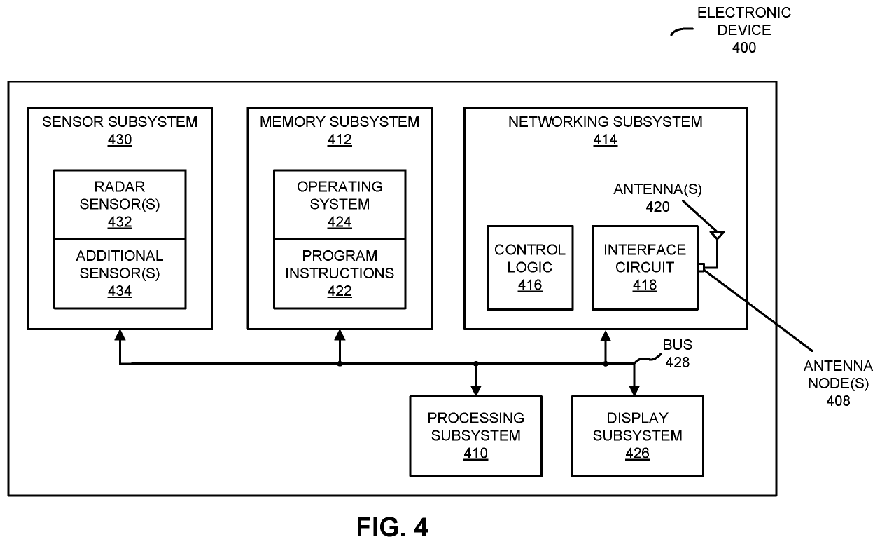

We now describe embodiments of an electronic device, which may perform at least some of the operations in the measurement technique. FIG. 4 presents a block diagram illustrating an example of an electronic device 400, such as electronic device 110 (FIGS. 1-2) or an electronic device that includes electronic device 110 (FIGS. 1-2). This electronic device may include processing subsystem 410, memory subsystem 412, networking subsystem 414 and sensor subsystem 430. Processing subsystem 410 includes one or more devices configured to perform computational operations. For example, processing subsystem 410 can include one or more microprocessors, ASICs, microcontrollers, programmable-logic devices, graphical processor units (GPUs) and/or one or more digital signal processors (DSPs).

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory (which collectively or individually are sometimes referred to as a ‘computer-readable storage medium’). In some embodiments, instructions for processing subsystem 410 in memory subsystem 412 include: one or more program modules or sets of instructions (such as program instructions 422 or operating system 424), which may be executed by processing subsystem 410. Note that the one or more computer programs may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as nodes 408, e.g., a pad, which can be coupled to the one or more antennas 420. Thus, electronic device 400 may or may not include the one or more antennas 420.) For example, networking subsystem 414 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

Note that a transmit or receive antenna pattern (or antenna radiation pattern) of electronic device 400 may be adapted or changed using pattern shapers (such as reflectors) in one or more antennas 420 (or antenna elements), which can be independently and selectively electrically coupled to ground to steer the transmit antenna pattern in different directions. (Alternatively or additionally, the transmit or receive antenna pattern may be adapted or changed using a phased array.) Thus, if one or more antennas 420 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 400 that is of interest, and one or more local minima that reduce gain in the direction of other electronic devices that are not of interest. In this way, the given antenna pattern may be selected, e.g., to target an object of interest in an environment of electronic device 400.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 400 may use the mechanisms in networking subsystem 414 for performing simple wireless communication between the electronic devices, e.g., transmitting frames and/or scanning for frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes an optional display subsystem 426 for displaying information on a display, which may include a display driver and the display, such as a liquid-crystal display, a multi-touch touchscreen, etc.

Furthermore, electronic device 400 may include a sensor subsystem 430, which may include one or more radar sensors 432 with one or more transmitters, one or more receivers, one or more sets of transmit antennas and one or more sets of receive antennas that perform MIMO radar measurements. In some embodiments, sensor subsystem 430 includes one or more image sensors that acquire images (such as a CCD or a CMOS sensor) and/or one or more additional sensors 434 (such as a light-intensity sensor, radar, sonar, lidar, etc.). These other or additional sensors may be used separately or in conjunction with the one or more radar sensors 432.

Electronic device 400 can be (or can be included in) a wide variety of electronic devices. For example, electronic device 400 can be (or can be included in): a desktop computer, a laptop computer, a subnotebook/netbook, a server, a computer, a mainframe computer, a cloud-based computer, a tablet computer, a smartphone, a cellular telephone, a smartwatch, a consumer-electronic device, a portable computing device, a transceiver, a measurement device, another electronic device and/or a vehicle.

Although specific components are used to describe electronic device 400, in alternative embodiments, different components and/or subsystems may be present in electronic device 400. For example, electronic device 400 may include one or more additional processing subsystems, memory subsystems, networking subsystems, display subsystems and/or sensor subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 414 or sensor subsystem 430. The integrated circuit may include hardware and/or software mechanisms that are used for transmitting wireless or radar signals from electronic device 400 and receiving wireless or radar signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the described single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

Moreover, another integrated circuit may implement some or all of the functionality related to the measurement technique.

In some embodiments, an output of a process for designing a given integrated circuit, or a portion of the given integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the given integrated circuit or the portion of the given integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the measurement technique may be implemented using program instructions 422, operating system 424 (such as a driver for interface circuit 418) or in firmware in interface circuit 418. Alternatively or additionally, at least some of the operations in the measurement technique may be implemented in a physical layer, such as hardware in interface circuit 418 or sensor subsystem 430.

In the preceding description, we refer to ‘some embodiments.’ Note that ‘some embodiments’ describes a subset of all of the possible embodiments, but does not always specify the same subset of embodiments. Note that numerical values in the preceding embodiments are illustrative examples of some embodiments. In other embodiments of the measurement technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a first transmitter configured to communicatively couple to a first antenna;
a second transmitter configured to communicatively couple to a second antenna; and
a first receiver configured to communicatively couple to a third antenna, wherein the electronic device is configured to:
provide, from the first transmitter, a first frequency-modulated continuous-wave (FMCW) radar signal, wherein a first carrier frequency of the first FMCW radar signal has a predefined variation as a function of time over a predefined frequency range;
provide, from the second transmitter, a second FMCW radar signal, wherein a second carrier frequency of the second FMCW radar signal has the predefined variation as a function of time over the predefined frequency range, and the predefined variation as a function of time of the second carrier frequency has a predefined delay relative to the predefined variation as a function of time of the first carrier frequency; and
receive, at the first receiver, a first reflected FMCW radar signal and a second reflected FMCW radar signal within a first bandwidth of the first receiver, wherein the first reflected FMCW radar signal corresponds to the first FMCW radar signal and the second reflected FMCW radar signal corresponds to the second FMCW radar signal, and wherein, at a given time, a frequency difference between carrier frequencies of the first and the second reflected FMCW radar signals, which corresponds to the predefined delay, is less than the first bandwidth.

2. The electronic device of claim 1, wherein the first bandwidth is less than a predefined value.

3. The electronic device of claim 1, wherein the first receiver is configured to concurrently receive the first reflected FMCW radar signal and the second reflected FMCW radar signal.

4. The electronic device of claim 1, wherein the first receiver is configured to receive the first reflected FMCW radar signal and the second reflected FMCW radar signal based at least in part on the predefined variation as a function of time over the predefined frequency range.

5. The electronic device of claim 4, wherein the first receiver is configured to adjust a center of the first bandwidth to track the predefined variation of the first carrier frequency and the second carrier frequency as a function of time over the predefined frequency range.

6. The electronic device of claim 1, wherein the electronic device is configured to perform multi-input multi-output (MIMO) measurements using the first reflected FMCW radar signal and the second reflected FMCW radar signal.

7. The electronic device of claim 1, wherein the first receiver is configured to down convert the first reflected FMCW radar signal and the second reflected FMCW radar signal to baseband based at least in part on the predefined variation as a function of time over the predefined frequency range.

8. The electronic device of claim 1, wherein the first receiver is configured to correct for the frequency difference.

9. The electronic device of claim 1, wherein the electronic device comprises a second receiver configured to communicatively couple to a fourth antenna; and
wherein the electronic device is configured to receive, at the second receiver, the first reflected FMCW radar signal and the second reflected FMCW radar signal within a second bandwidth of the second receiver, wherein the frequency difference is less than the second bandwidth.

10. The electronic device of claim 9, wherein the second bandwidth is less than the predefined value.

11. The electronic device of claim 9, wherein the first antenna and the third antenna have a first polarization, and the second antenna and the fourth antenna have a second polarization.

12. The electronic device of claim 1, wherein the predefined variation as a function of time comprises: a sine wave, a sawtooth wave, a triangle wave or a square wave.

13. The electronic device of claim 1, wherein the first FMCW radar signal has a different encoding from the second FMCW radar signal.

14. A non-transitory computer-readable storage medium for use in conjunction with an electronic device, the computer-readable storage medium configured to store program instructions that, when executed by the electronic device, cause the electronic device to:
providing, from a first transmitter in the electronic device, a first frequency-modulated continuous-wave (FMCW) radar signal, wherein a first carrier frequency of the first FMCW radar signal has a predefined variation as a function of time over a predefined frequency range;
providing, from a second transmitter in the electronic device, a second FMCW radar signal, wherein a second carrier frequency of the second FMCW radar signal has the predefined variation as a function of time over the predefined frequency range, and the predefined variation as a function of time of the second carrier frequency has a predefined delay relative to the predefined variation as a function of time of the first carrier frequency; and
receiving, at a first receiver in the electronic device, a first reflected FMCW radar signal and a second reflected FMCW radar signal within a first bandwidth of the first receiver, wherein the first reflected FMCW radar signal corresponds to the first FMCW radar signal and the second reflected FMCW radar signal corresponds to the second FMCW radar signal, and wherein, at a given time, a frequency difference between carrier frequencies of the first and the second reflected FMCW radar signals, which corresponds to the predefined delay, is less than the first bandwidth.

15. The non-transitory computer-readable storage medium of claim 14, wherein the first receiver receives the first reflected FMCW radar signal and the second reflected FMCW radar signal based at least in part on the predefined variation as a function of time over the predefined frequency range.

16. The non-transitory computer-readable storage medium of claim 14, wherein the electronic device performs multi-input multi-output (MIMO) measurements using the first reflected FMCW radar signal and the second reflected FMCW radar signal.

17. A method for performing radar measurements, comprising:
by an electronic device:
providing, from a first transmitter in the electronic device, a first frequency-modulated continuous-wave (FMCW) radar signal, wherein a first carrier frequency of the first FMCW radar signal has a predefined variation as a function of time over a predefined frequency range;
providing, from a second transmitter in the electronic device, a second FMCW radar signal, wherein a second carrier frequency of the second FMCW radar signal has the predefined variation as a function of time over the predefined frequency range, and the predefined variation as a function of time of the second carrier frequency has a predefined delay relative to the predefined variation as a function of time of the first carrier frequency; and
receiving, at a first receiver in the electronic device, a first reflected FMCW radar signal and a second reflected FMCW radar signal within a first bandwidth of the first receiver, wherein the first reflected FMCW radar signal corresponds to the first FMCW radar signal and the second reflected FMCW radar signal corresponds to the second FMCW radar signal, and wherein, at a given time, a frequency difference between carrier frequencies of the first and the second reflected FMCW radar signals, which corresponds to the predefined delay, is less than the first bandwidth.

18. The method of claim 17, wherein the first receiver receives the first reflected FMCW radar signal and the second reflected FMCW radar signal based at least in part on the predefined variation as a function of time over the predefined frequency range.

19. The method of claim 18, wherein the first receiver adjusts a center of the first bandwidth to track the predefined variation of the first carrier frequency and the second carrier frequency as a function of time over the predefined frequency range.

20. The method of claim 17, wherein the electronic device performs multi-input multi-output (MIMO) measurements using the first reflected FMCW radar signal and the second reflected FMCW radar signal.
